(19) United States
(12) Patent Application Publication
(10) Pub. No.: US 2009/0020216 A1
(43) Pub. Date: Jan. 22, 2009

(54) Method Of Making Tailored Core Laminated Sheet Metal

(75) Inventors: Robert B. Ruokolainen, Livonia, MI (US); Xiaorong Jin, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/233,721

(22) Filed: Sep. 19, 2008

Related U.S. Application Data
(63) Continuation-in-part of application No. 11/780,506, filed on Jul. 20, 2007.

(51) Int. Cl. B32B 37/12; B32B 38/10

(52) U.S. Cl. 156/184; 156/250; 156/291

(57) ABSTRACT

A method for laminating metal sheets together with a first polymer selected for its adhesive characteristics and a second polymer selected for its viscoelastic characteristics. One of the first sheets of metal or second sheets of metal is fed across a first engraved roller having recesses that carry the first polymer and deposit the first polymer onto only selected regions of the sheet of metal. One of the first and second sheets of metal is across a second engraved roller having recesses that carry the second polymer and deposit the second polymer onto only selected regions of the sheet of metal. And then the first and second sheets of metal are married together so that the first polymer and the second polymer are engaged between the first and second sheets in different regions, and the polymers are cured to thereby attach the sheets together as a laminated metal sheet.

This application is a continuation in part of U.S. patent application Ser. No. 11/780,506, filed Jul. 20, 2007, entitled Tailored Core Laminated Sheet Metal.

### FIELD OF THE INVENTION

The present invention relates to a method of making a laminated sheet metal material having a polymer core tailored to provide varying regions of metal adhesion and vibration dampening.

### BACKGROUND OF THE INVENTION

It is known in modern automobile manufacture to employ laminated metal, particularly laminated steel, in the forming of components such as oil pans, rocker covers, wheelhouse inners and front-dash structures. Laminated metal is comprised of two sheets of metal, such as steel, aluminum or magnesium, with a layer of polymer interposed therebetween.

The polymer core layer acts to adhere the metal sheets together and also provides a visco-elastic coupling between the metal sheets that dampens noise and vibration.

The laminated sheet metal can be shaped by known metal forming processes such as stamping. Laminated metal is known to provide a good combination of vibration damping properties and high strength-to-weight ratios and is accordingly of interest to meeting the exacting performance demands of the automobile industry.

It would be desirable to provide a method for making a laminated sheet metal, which could be tailored to provide optimal characteristics of metal adhesion and vibration damping properties.

### SUMMARY OF THE INVENTION

A method is provided for laminating metal sheets together with a first polymer selected for its adhesive characteristics and a second polymer selected for its viscoelastic characteristics. One of the first sheets of metal or second sheets of metal is fed across a first engraved roller having recesses that carry the first polymer and deposit the first polymer onto only selected regions of the sheet of metal. One of the first and second sheets of metal is across a second engraved roller having recesses that the carry the second polymer and deposit the second polymer onto only selected regions of the sheet of metal. And then the first and second sheets of metal are married together so that the first polymer and the second polymer are engaged between the first and second sheets in different regions, and the polymers are cured to thereby attach the sheets together as a laminated metal sheet.

### BRIEF DESCRIPTION OF THE DRAWINGS

The present invention will become more fully understood from the detailed description and the accompanying drawings, wherein:

FIG. 1 is a perspective view of a laminated sheet metal having island-like regions of adhesive dispersed within the visco-elastic material.

FIG. 2 is a view similar to FIG. 1 but showing an alternative embodiment in which adhesive material is placed in the regions along the edge of the sheet metal laminate and the visco-elastic material is located in regions further away from the edges of the laminated metal.

FIG. 3 is another embodiment of the invention in which the polymer core between the metal plates is formed by alternating strips of adhesive material and visco-elastic material.

FIG. 4 is a perspective view of a vehicle seat pan construction stamped from the laminated sheet metal.

FIG. 5 is a schematic of a method for making the laminated sheet metal of FIG. 1.

FIG. 6 is view of one of the engraved rollers of FIG. 5.

FIG. 7 is a view of the other of the engraved rollers of FIG. 5.

FIG. 8 is a schematic of a method for making the laminated sheet metal of FIG. 2.

FIG. 9 is view of one of the engraved rollers of FIG. 8.

FIG. 10 is a view of another of the engraved rollers of FIG. 5.

FIG. 11 is a view of the third of the engraved rollers of FIG. 8.

### DETAILED DESCRIPTION OF THE EXEMPLARY EMBODIMENTS

The following description of certain exemplary embodiments is merely exemplary in nature and is not intended to limit the invention, its application, or uses.

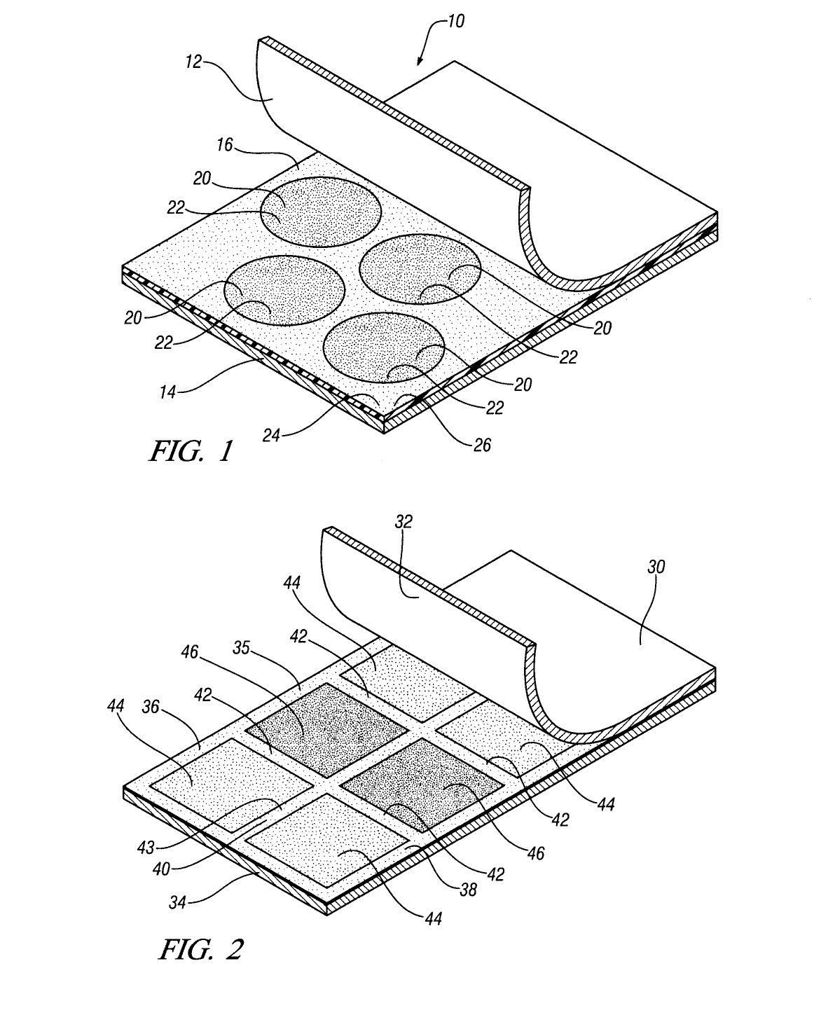

Referring to FIG. 1, it is seen that a laminated sheet metal panel or strip 10 is comprised of an upper or top metal sheet 12 and a lower or bottom metal sheet 14 that are joined together by a polymer core layer 16. The metal sheet 12 and the metal sheet 14 may be steel or aluminum or magnesium or some other metallic material or alloy. Interstitial steel is often used, and one or both of the metal sheets 12 and 14 can have a galvanized coating, on either both sides of the sheet or on a single side of the sheet.

As seen in FIG. 1, the polymer core layer 16 is comprised of several spot or island regions 20 of a first polymer material 22, and a surrounding larger region 24 of a second polymer material 26. The first polymer material 22 is selected from among the commercially available polymers primarily for its adhesive characteristics, and the second polymer material 26 is selected from among the commercially available polymers primarily for its visco-elastic characteristics. Thus, although each of the polymer materials 22 and 26 will have both adhesive and visco-elastic characteristics, the first polymer material 22 has adhesive qualities that are superior to the adhesive qualities of the second polymer material 26, and the second polymer material 26 has visco-elastic qualities that are superior to the visco-elastic qualities of the first polymer material 22.

Accordingly, the product designer can tailor the core of the laminated sheet metal 10 to provide selected regions 20 of high adhesion interspersed among the other region 24 of high visco-elastic qualities. An example of a first polymer material 22 that would be chosen for its adhesive qualities is an epoxy. An example of a second polymer material 26 that is chosen for its enhanced visco-elastic damping qualities is a styrene-ethylene/butylene-styrene (SEBS) based polymer.

It will be understood that the laminated sheet metal 10 of FIG. 1 can be formed in a continuous strip manufacturing process where the metal sheets 12 and 14 are progressively unrolled from coils of sheet material. Alternatively, the laminated sheet metal 10 of FIG. 1 can be manufactured by first blanking the top metal sheet 12 and the bottom metal sheet 14 from a coil or a blank, and then applying the polymer materials 22 and 26 between the two blanks.

Referring to FIG. 2, another laminated sheet metal panel or strip 30 is shown having an upper metal sheet 32 and a lower metal sheet 34. In the example of FIG. 2, a first polymer material 35 selected for its adhesive qualities is provided at a left edge strip 36 and right edge strip 38 of the laminated sheet metal 30. In addition, this first polymer material 35 is also located in a longitudinal strip 40 along the center of the laminated sheet metal 30, and at crossbars 42, so that the first polymer material 35 will form a latticework 43 of high adhesion characteristic that will adhesively bond the metal sheets 32 and 34 together. FIG. 2 also shows that a second polymer material 44 is located in the some of the interstices of the latticework 43 formed by the first polymer material 35, and a third polymer material 46 is located in some of the interstices of the latticework 43. The second polymer material 44 and the third polymer material 46 are selected for their visco-elastic characteristics, and thus allow the design of a laminated sheet metal 30 that will have varying visco-elastic qualities at selected areas of the laminated sheet metal 30. Thus, as seen in FIG. 2, the metal sheets 32 and 34 will be effectively bonded together by the latticework 43 of the adhesive first polymer material 35 and the larger interstices or regions between the strips 36, 38, and 40 and the crossbars 42 of the first polymer material 35 will be occupied by the visco-elastic materials 44 and 46 to effectively and variably dampen the transmission of noise and vibration through the laminated sheet metal 30.

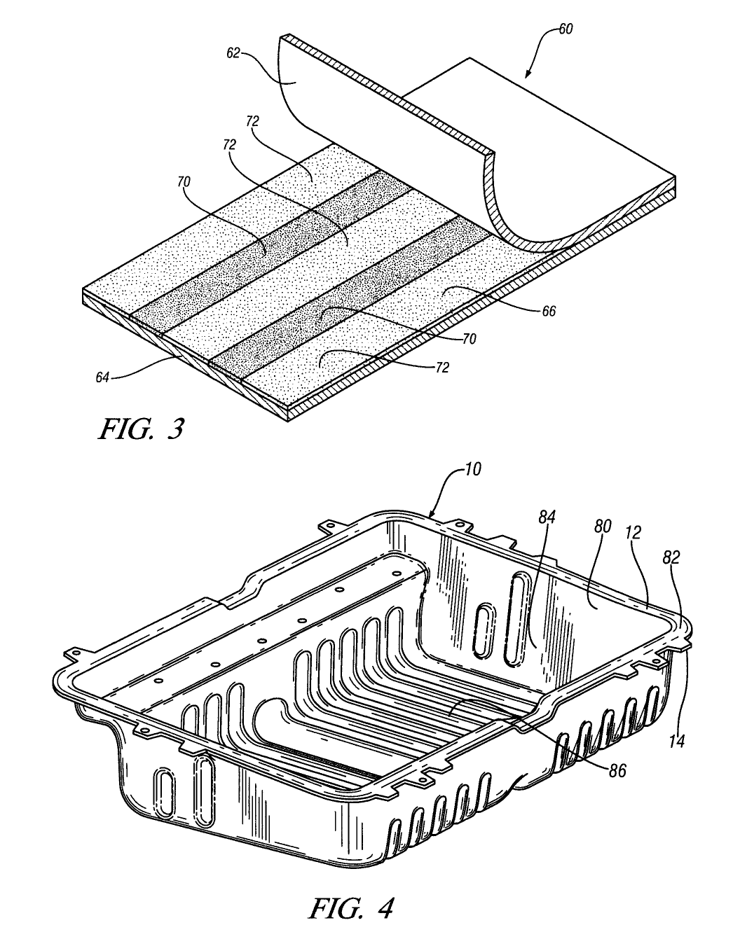

Referring to FIG. 3, a third embodiment of the invention is shown where a laminated sheet metal 60 includes an upper metal sheet 62 and a lower metal sheet 64 having a polymer core 66 therebetween which is provided by alternating strips 70 of a first polymer chosen for its adhesive qualities and a second polymer 72 chosen for its visco-elastic damping qualities. In this way, alternating strip regions of high adhesion and high visco-elastic qualities can be readily laid down for coil processing by passing the lower metal sheet 64 beneath of a row of polymer-dispensing nozzles or by mounting a row of nozzles on a robotic arm which passes over top the lower sheet 64. If desired, two or more different polymers can be used for their adhesive qualities and two or more different polymers can be used for their visco-elastic damping qualities. The width of the strips can be varied as desired.

FIG. 4 shows a cup-shaped product 80, such as an oil pan, or a vehicle seat pan, which has been stamped from the laminated sheet metal 10 having alternating regions of first and second polymers.

The laminated sheet metal 10 can be particularly tailored to optimize the qualities that are desired from the manufacture of the particular product, such as the cup-shaped tub product 80, shown in FIG. 4. The tub 80 has a peripheral rim flange 82 extending around the outside thereof where the edges of the upper metal sheet 12 and lower metal sheet 14 will be exposed to the elements, including potentially, moisture, salt, and solvents. Accordingly, the designer may choose to employ a more adhesive polymer at those regions of the laminated sheet metal 10 that are destined to become the flange 82 of the stamped sheet metal tub 80, to thereby maximize the adherence of the upper metal sheet 12 and lower metal sheet 14 to guard against the possibility of delamination at the edges of the tub 80.

Furthermore, during the sheet metal forming process, such as stamping or deep-drawing to form the cup-shape of the tub 80, the laminated sheet metal 10 will be subjected to a shear and compressive forces to sever the laminated sheet metal 10 around the flange 82 and various shear and compressive forces to draw the depth of side wall 84 of the tub 80. Accordingly, the designer may choose to employ a more adhesive or less adhesive polymer at those regions of the laminated sheet metal 10 that are destined to be stressed during the forming process.

In other regions of the tub 80, such as the generally planar bottom wall 86, the designer may choose a more visco-elastic polymer, or more than one visco-elastic polymer to optimize the noise and vibration dampening characteristics of the large planar bottom wall 86.

In view of the foregoing, it will be appreciated that a skilled designer of products can tailor a laminated sheet metal in a way that accomplishes the best optimized tradeoff of the adhesive and visco-elastic characteristics desirable for the finished product. The polymers can be dispensed in the paths and patterns shown in FIGS. 1-3, and in variation thereof. Any number of two or more different polymers can be used. In addition, although the drawings show just two sheets of metal adhered together, a plurality of metal sheets can be used to form the laminated sheet metal by stacking alternating layers of sheet metal and polymers.

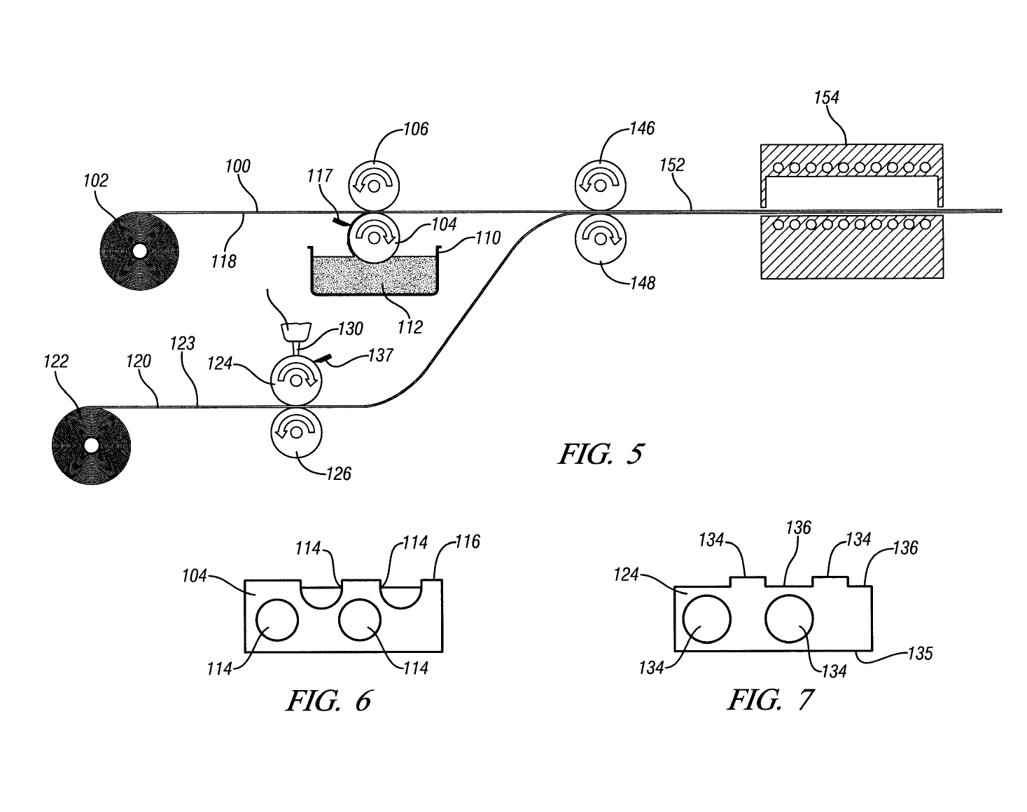

FIG. 5 is a schematic representation of a method for making the laminated sheet metal strip of FIG. 1. In FIG. 5, an upper metal sheet 100 is unwound from a coil 102 and passes between an engraved roller 104 and a pressure roller 106. The engraved roller 104 dips into a bath 110 of a the first polymer material 112. The engraved roller 104 is shown in FIG. 6 and has circular shaped recesses 114 on an outer circumferential surface 116 thereof. As the engraved roller 104 rolls through the bath 110, the first polymer material 112 coats the outer circumferential surface 116. A blade 117 scrapes the excess polymer material 112 off of the circumferential surface 116 so that the polymer material 112 rests in only the recesses 114. As the upper metal sheet 100 passes over the engraved roller 104, the first polymer material 112 residing in the recesses 114 is dispensed onto a lower face 118 of the upper metal sheet 100.

Also, FIG. 5 shows a lower metal sheet 120 that is unwound from a coil 122 and passes between an engraved roller 124 and a pressure roller 126. A trough 130 filled with a second polymer material 132 dispenses the second polymer material 132 onto the engraved roller 124. As seen in FIG. 7, the second engraved roller 124 has circular shaped raised portions 134 on the outer circular circumferential surface 135 that create a recessed region 136 that surrounds the circular shaped raised portions 134. As the engraved roller 124 rolls under the trough 130, the second polymer material 132 is deposited in the recessed region 136 and the excess is scraped by a blade 137. As the lower metal sheet 120 passes under the engraved roller 124, the second polymer material 132 residing in the recessed region 136 is transferred onto the upper face 123 of the lower metal sheet 120.

Referring again to FIG. 5, it is seen that after the upper metal sheet 100 and the lower metal sheet 120 have been coated with the polymer materials as described above, the metal sheets are laminated together by passing the sheets between an upper laminating roller 146 and a lower laminating roller 148. As the metal sheets 100 and 120 come together and are pressed between the rollers 146 and 148, the metal sheets align with one another such that the circular spots of the first polymer material 112 that were previously deposited onto the lower face 118 of the upper metal sheet 100 will register with and be received into the uncoated regions on the upper face 123 of the lower metal sheet 120. Likewise the region of second polymer 132 material that had been previously deposited onto the upper face 123 of the lower metal 120 sheet will register with and be received into the uncoated regions of the lower face 118 of the upper metal sheet 100. After being pressed together to form a laminated strip 152, the laminated strip 152 passes through an oven or other heating apparatus 154 so that the first and second polymer materials are cured. Thereafter, the laminated strip 152 can be blanked into panels or wound on a coiler.

FIG. 8 shows another embodiment of the method for laminating the metal sheets. Referring again to FIG. 2, it is seen that the laminated metal of FIG. 2 is made using one polymer selected for its adhesive properties and two different polymers selected for their viscoelastic properties. FIG. 8 shows a schematic for applying the three different polymers to the selected regions of one of the metal sheets, and then laminating the two metal sheets together.

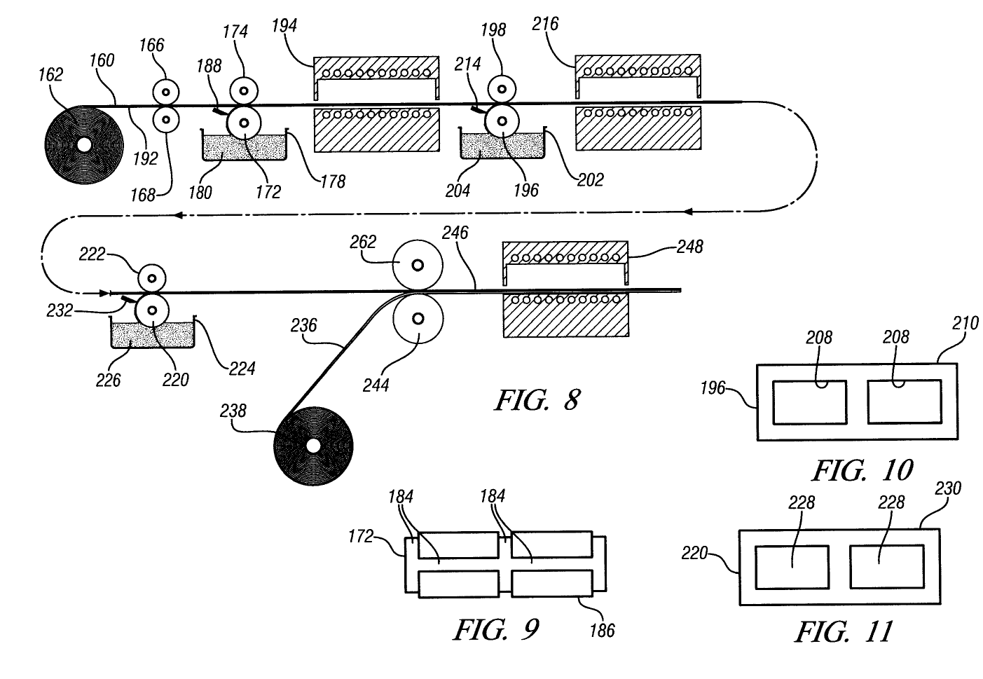

In particular, an upper metal sheet 160 is unwound from a coil 162 by a pair of feed rollers 166 and 168, and passes between an engraved roller 172 and a pressure roller 174. The engraved roller 172 dips into a bath 178 of a first polymer material 180. The engraved roller 172 is shown in FIG. 9 and has recesses 184 on the outer circumferential surface 186 thereof in the form of a latticework. As the engraved roller 172 rolls through the bath 178, the first polymer material 180 coats the outer circumferential surface 186. A blade 188 scrapes the excess first polymer material 180 off of the circumferential surface 186 so that the first polymer material 180 rests in only the recesses 184. As the upper metal sheet 160 passes over the engraved roller 172, the first polymer material 180 residing in the recesses 184 is dispensed onto the lower face 192 of the upper metal sheet 160. The upper metal sheet 160 then passes through an oven 194 or other heating device to partially cure the first polymer material 180.

The upper metal sheet 160 then passes between an engraved roller 196 and a pressure roller 198. The engraved roller 196 dips into a bath 202 of a second polymer material 204. The engraved roller 196 is shown in FIG. 10 and has rectangular shaped recesses 208 on the outer circumferential surface 210 thereof. As the engraved roller 196 rolls through the bath 202, the second polymer material 204 coats the outer circumferential surface 210. A blade 214 scrapes the excess second polymer material 204 off of the circumferential surface 210 so that the second polymer material 204 rests in only the recesses 208. As the upper metal sheet 160 passes over the engraved roller 196, the second polymer material 204 residing in the recesses 208 is dispensed onto the lower face 192 of the upper metal sheet 160, within some of the open spaces of the latticework pattern of the first polymer material 180 that had been deposited on the upper metal sheet 160 by the first engraved roller 172. The upper metal sheet 160 then passes through an oven 216 or other heating device to partially cure the second polymer material 204.

The upper metal sheet 160 next passes between an engraved roller 220 and a pressure roller 222. The engraved roller 220 dips into a bath 224 of a third polymer material 226. The engraved roller 220 is shown in FIG. 11 and has rectangular shaped recesses 228 on the outer circumferential surface 230 thereof. As the engraved roller 220 rolls through the bath 224, the third polymer material 226 coats the outer circumferential surface 230. A blade 232 scrapes the excess third polymer material 226 off of the circumferential surface 230 so that the third polymer material 226 rests in only the recesses 228. As the upper metal sheet 160 passes over the engraved roller 220, the third polymer material 226 residing in the recesses 228 is dispensed onto the lower face 192 of the upper metal sheet 160 within the remaining uncoated regions of the latticework formed by the first polymer material 180. An oven, not shown, may be provided in order to partially cure this third polymer material 226.

Referring again to FIG. 8, it is seen that after the upper metal sheet 160 has been coated with the three different polymer materials as descried above, the upper metal sheet 160 is laminated with a lower metal sheet 236 unwound from coil 238 by pressing the sheets between an upper laminating roller 242 and a lower laminating roller 244. After being pressed together to form a laminated strip 246, the laminated strip 246 passes through an oven 248 or other heating apparatus so that the first and second and third polymer materials are cured. Thereafter the laminated strip 246 can be blanked into panels or wound on a coiler.

Thus it is seen that a method is provided for making a laminated strip. The polymer materials can be applied onto one of the sheets, as shown in FIG. 8, or the polymer materials can be applied onto different sheets that are then married together as shown in FIG. 5. And in the case of making the laminated sheet of FIG. 2 in which three different polymers are employed, it may be desirable to deposit one of the polymers on one of the sheets and two of the polymers on the other sheet. Depending upon the characteristics and thickness of the deposit of polymer material, it may be desirable or necessary to heat the individual polymer materials after they are deposited. Although the drawings herein show the metal sheets as being unwound from a coil for continuous processing, it will be understood that the method can also be employed by feeding sheet metal blanks trough the series of engraved rollers.

What is claimed is:

1. A method for laminating together a first sheet of metal and a second sheet of metal comprising:
providing a first polymer material selected for its adhesive characteristics;
providing a second polymer material selected for its viscoelastic characteristics;
feeding one of the first sheet of metal or second sheet of metal across a first engraved roller having recesses that carry the first polymer material and deposit the first polymer material onto only selected regions of the sheet of metal;
feeding one of the first and second sheets of metal across a second engraved roller having recesses that carry the second polymer material and deposit the second polymer onto only selected regions of the sheet of metal;
and then marrying the first and second sheets of metal together so that the first polymer material and the second polymer material are engaged between the first and second sheets in different regions;
and curing the polymers to thereby attach the sheets together as a laminated metal sheet.

2. The method of claim 1 further comprising both of the first polymer material and the second polymer material being deposited onto the same metal sheet.

3. The method of claim 1 further comprising the first polymer material being deposited onto either the first metal sheet or the second metal sheet, and the second polymer material being deposited onto the other of the first metal sheet or second metal sheet.

4. The method of claim 1 further comprising the curing of the first and second polymer materials occurs in an oven.

5. The method of claim 1 further comprising the first and second metal sheets being unwound from a coil and after the laminated metal sheet is formed by curing the first and second polymer materials the laminated metal sheet is then rewound upon a coil.

6. The method of claim 1 further comprising the first and second metal sheets being unwound from a coil and after the laminated metal sheet is formed by curing the first and second polymer materials the laminated metal sheet is then cut into blanks.

7. The method of claim 1 further comprising the first and second metal sheets being sheet metal blanks.

8. The method of claim 1 further comprising said recesses of the engraving rollers picking up the respective polymeric material by either passing through a bath of the polymeric material or by passing beneath a trough of the polymeric material.

9. The method of claim 1 further comprising:
selecting a third polymer selected for characteristics different from the first and second polymers;
and feeding one of the first sheet of metal and second sheet of metal across a third engraved roller, said third engraved roller having recesses that carry the third polymer and deposit the third polymer onto selected regions of the sheet not already deposited with the first polymer or second polymer so that when the polymers are cured the sheets are attached together by the different polymers in different regions.

10. A method for laminating together a first sheet of metal and a second sheet of metal comprising:
providing a first polymer material selected for its adhesive characteristics;
providing a second polymer material selected for its viscoelastic characteristics;
feeding a first sheet of metal across a first engraved roller, said first engraved roller having recesses that carry the first polymer and then deposit the first polymer onto selected regions of the first sheet while leaving a bare uncoated region of the first sheet;
feeding a second sheet of metal across a second engraved roller, said second engraved roller having recesses that carry the second polymer and then deposit the second polymer onto selected regions of the second sheet while leaving a bare uncoated region of the second sheet;
and then marrying the first and second sheets together with the first polymer of the selected regions of the first sheet engaging with the bare uncoated region of the second sheet and the second polymer of the selected regions of the second sheet engaging with the bare uncoated region of the first sheet;
and curing the polymers to thereby attach the sheets in a laminate.

11. The method of claim 10 further comprising:
selecting a third polymer selected for characteristics different from the first and second polymers;
and feeding one of the first sheet of metal and second sheet of metal across a third engraved roller, said third engraved roller having recesses that carry the third polymer and deposit the third polymer onto selected regions of the sheet not already deposited with the first polymer or second polymer.

12. The method of claim 10 further comprising the curing of the first and second polymer materials occurs in an oven.

13. The method of claim 10 further comprising said recesses of the engraving rollers picking up the respective polymeric material by either passing through a bath of the polymeric material or by passing beneath a trough of the polymeric material.

14. A method for laminating together a first sheet of metal and a second sheet of metal comprising:
providing a first polymer material selected for its adhesive characteristics;
providing a second polymer material selected for its viscoelastic characteristics;
feeding a first sheet of metal across a first engraved roller; said first engraved roller having recesses that carry the first polymer from the bath and then deposit the first polymer onto selected regions of the first sheet while leaving a bare uncoated region of the first sheet;
then feeding the first sheet of metal across a second engraved roller, said second engraved roller has recesses that carry the second polymer and then deposit the second polymer onto selected regions of the first sheet not deposited with the first polymer,
and then marrying the first and second sheets together with the first polymer of the selected regions of the first sheet engaging with the bare uncoated region of the second sheet and the second polymer of the selected regions of the second sheet engaging with the bare uncoated region of the first sheet;
and curing the polymers to thereby attach the sheets in a laminate

15. The method of claim 14 further comprising:
selecting a third polymer selected for characteristics different from the first and second polymers;
providing a third engraved roller and feeding the first sheet of metal across the second engraved roller, said third engraved roller having recesses that carry the third polymer and deposit the third polymer onto selected regions of the first sheet not already deposited with the first polymer or second polymer;

16. The method of claim 14 further comprising the curing of the first and second polymer materials occurs in an oven.

17. The method of claim 14 further comprising said recesses of the engraving rollers picking up the respective polymeric material by either passing through a bath of the polymeric material or by passing beneath a trough of the polymeric material.
